(19) United States
(12) Patent Application Publication
(10) Pub. No.: US 2012/0074603 A1
(43) Pub. Date: Mar. 29, 2012

(54) Delivery of Herbicidal Actives From Highly Charged Microcapsules

(76) Inventors: Daniel H. Traynor, Sarasota, FL (US); Henry G. Traynor, Sarasota, FL (US); Daniel H. Traynor, Sarasota, FL (US)

(21) Appl. No.: 13/168,680

(22) Filed: Jun. 24, 2011

Related U.S. Application Data
(60) Provisional application No. 61/358,724, filed on Jun. 25, 2010.

(51) Int. Cl. B01J 13/22

(52) U.S. Cl. 264/4.1

(57) ABSTRACT

This invention relates to a method for forming hollow silica-based particles suitable for containing one or more herbicidal active ingredients. In the method for forming the herbicidal composition, an emulsion is prepared wherein the emulsion includes a continuous phase that is polar or non-polar, and a dispersed phase comprising droplets including (i) a polar herbicidal active ingredient when the continuous phase is non-polar or (ii) a non-polar herbicidal active ingredient when the continuous phase is polar. A silica precursor is added to the emulsion such that the silica precursor can be emulsion templated on the droplets to form hollow silica-based particles that encapsulate the herbicidal active ingredient,

### CROSS-REFERENCES TO RELATED APPLICATIONS

This application claims priority from U.S. patent application Ser. No. 61/358,724 filed Jun. 25, 2010.

### STATEMENT REGARDING FEDERALLY SPONSORED RESEARCH

Not Applicable.

### BACKGROUND OF THE INVENTION

1. Field of the Invention

This invention relates to hollow silica-based particles suitable for containing and delivering one or more herbicidal active ingredients.

2. Description of the Related Art

Herbicides are active ingredients which penetrate plant cells or plant tissue and damage and/or kill them. Some herbicides act on the transport system of plants by inhibiting photosynthesis or biosynthesis, leading to the inhibition of germination and growth, or to the death of the plants. The bioactivity of a herbicide can be determined by reference to plant growth or to the damage of the plants caused by the effect of the herbicide active ingredient on the leaf as a function of the activity time and the active concentration.

The herbicide must wet the chlorophyll and remain there for a sufficient time, or the herbicide must penetrate through the surface of the leaf to damage or kill the plant. An additive that improves the wettability of the active ingredient can be added to a herbicide. Also, an additive can be added to a herbicide wherein the additive can facilitate and accelerate penetration of the herbicide through the surface of the leaf into the plant.

One approach to providing an active ingredient to a surface is to encapsulate the active ingredient in order to protect the active ingredient, control the release of the active ingredient, and/or modify the function of the active ingredient. Methods for encapsulation of an active ingredient, such as sol-gel encapsulation, are known in the art. See, for example U.S. Patent Application Publication No. 2008/0317795 to Traynor et al.

Still, there is a need for methods and compositions for improving the bioactivity of herbicides.

### SUMMARY OF THE INVENTION

The invention meets the foregoing needs by providing a herbicidal composition including a sol-gel microcapsule; and a herbicidal active ingredient encapsulated in a shell of the microcapsule. The microcapsule improves the bioactivity of the herbicide encapsulated in the shell of the microcapsule.

In one aspect, the invention provides a herbicidal composition including a sol-gel microcapsule; and a herbicidal active ingredient encapsulated in a shell of the microcapsule, wherein the herbicidal active ingredient is selected from the group consisting of glyphosate, glyphosate salts, and mixtures thereof.

In another aspect, the invention provides a herbicidal composition including a sol-gel microcapsule; and a herbicidal active ingredient associated with a shell of the microcapsule, wherein the herbicidal active ingredient is a glyphosate salt, and the glyphosate salt is released on leaves, stems, flowers and/or roots of a plant due to dissolution of the glyphosate salt by contact of water vapor from transpiration of the plant.

In yet another aspect, the invention provides a herbicidal composition including a sol-gel microcapsule; a herbicidal active ingredient encapsulated in a shell of the microcapsule; and a surfactant encapsulated in the microcapsule, wherein the surfactant enhances the activity of the herbicidal active ingredient.

In still another aspect, the invention provides a herbicidal composition including a sol-gel microcapsule; and a herbicidal active ingredient encapsulated in a shell of the microcapsule, wherein the herbicidal active ingredient is a powder that is released on leaves, stems, flowers and/or roots of a plant due to the contact of water vapor from transpiration of the plant.

In yet another aspect, the invention provides a herbicidal composition including a sol-gel microcapsule; and a herbicidal active ingredient encapsulated in a shell of the microcapsule, wherein the shell of the microcapsule degrades due to a pH change due to the contact of water vapor from transpiration of the plant.

In still another aspect, the invention provides a herbicidal composition including a sol-gel microcapsule; and a herbicidal active ingredient encapsulated in a shell of the microcapsule, wherein the shell of the microcapsule includes a salt, and the herbicidal active ingredient is released on leaves, stems, flowers and/or roots of a plant due to dissolution of the salt by contact of water vapor from transpiration of the plant.

In yet another aspect, the invention provides a herbicidal composition including a sol-gel microcapsule; and a herbicidal active ingredient encapsulated in a shell of the microcapsule, the shell of the microcapsule being coated with a polymer, wherein the herbicidal active ingredient is associated with the polymer, and the herbicidal active ingredient is released on leaves, stems, flowers and/or roots of a plant due to dissolution of the polymer by contact of water vapor from transpiration of the plant.

In these aspects of the invention, the sol-gel microcapsule can have a zeta potential of at least about 40 mV. Preferably, the sol-gel microcapsule is capable of binding to a plant surface wherein an average of at least about 50% of microcapsules remain bound to the plant surface for an average of greater than at least about 4 hours. The microcapsule can comprise a cationic agent such as a cationic polymer. Preferably, the microcapsule experiences an average of greater than about 50% breakage when applied to a plant surface. Preferably, the breakage substantially occurs on initial application to the plant surface. Preferably, the breakage occurs due to the conditions of surface application. Preferably, the condition of surface application is friction, pressure, light, pH change, or enzymatic action.

In these aspects of the invention, the herbicidal active ingredient can be non-selective. The herbicidal active ingredient can be selective for monocot species. The herbicidal active ingredient can be selective for dicot species.

In still another aspect, the invention provides a herbicidal composition including a sol-gel microcapsule; and a polar herbicidal active ingredient encapsulated in a shell of the microcapsule.

In yet another aspect, the invention provides a herbicidal composition including a sol-gel microcapsule; and a non-polar herbicidal active ingredient encapsulated in a shell of the microcapsule.

The microcapsule can be formed from a silica precursor having the general formula (I):

R¹_{x—Si—(OR}²)_{y} (I)

wherein R¹ is selected from substituted and unsubstituted alkyl, substituted and unsubstituted aryl, alcohols, amines, amides, aldehydes, acids, esters, and functional groups having an unsaturated carbon-carbon bond, R² is an alkyl group, x+y=4, and y=1, 2 or 3. Preferably, R¹ is selected from substituted and unsubstituted alkyl, substituted and unsubstituted aryl, functional groups having an unsaturated carbon-carbon bond, functional groups having a carboxylic acid group, polymers of alkylene oxide, and aminofunctional groups. Preferably, x=1. In certain embodiments, R¹ can be phenyl, or C₁₂—C₂₄ alkyl, or substituted or unsubstituted acrylic acid, or polyethylene glycol, or alkylamine, or alkyl carboxylate, or alkyl quaternary amine.

The herbicidal composition can be prepared using a method which comprises preparing an emulsion including a continuous phase that is polar or non-polar and a dispersed phase comprising droplets including (i) a polar herbicidal active ingredient (such as glyphosate) when the continuous phase is non-polar or (ii) a non-polar herbicidal active ingredient (such as atrazine) when the continuous phase is polar; and adding the silica precursor of Formula (I) to the emulsion such that the silica precursor can be emulsion templated on the droplets to form hollow silica-based particles.

In still another aspect, the invention provides a method of manufacturing a herbicidal composition. The method comprises (a) combining a non-polar material including a herbicidal active ingredient and an aqueous phase; (b) agitating the combination formed in (a) to form an oil-in-water emulsion wherein the non-polar material including a herbicidal active ingredient comprises the dispersed phase; (c) adding a surfactant; (d) adding a cationic agent; (e) adding a gel precursor to the oil-in-water emulsion; and (f) mixing the composition from step (e) while the gel precursor hydrolyzes and sol-gel capsules are formed which comprise the non-polar herbicidal active ingredient. The method can further comprise (g) drying the microcapsules. The method of manufacturing can produce a microcapsule having zeta potential of at least about 30 mV. The cationic agent can be added after the addition of the gel precursor. The cationic agent can comprise a cationic polymer.

In yet another aspect, the invention provides a method of manufacturing a herbicidal composition. The method comprises (a) combining a polar material including a herbicidal active ingredient and a non-polar phase; (b) agitating the combination formed in (a) to form a water-in-oil emulsion wherein the polar material including a herbicidal active ingredient comprises the dispersed phase; (c) adding a surfactant; (d) adding a cationic agent; (e) adding a gel precursor to the water-in-oil emulsion; and (f) mixing the composition from step (e) while the gel precursor hydrolyzes and sol-gel capsules are formed which comprise the polar herbicidal active ingredient. The herbicidal active ingredient can be a glyphosphate. The method can include step (g) drying the microcapsules. The method of manufacturing can produce a microcapsule having zeta potential of at least about 30 mV. The cationic agent can be added after the addition of the gel precursor. The cationic agent can comprises a cationic polymer.

In still another aspect, the invention provides a method for increasing the bioactivity of a herbicide. The method comprises encapsulating the herbicide in a sol-gel microcapsule wherein the herbicide is in the salt form such that the herbicide is released on leaves, stems, flowers and/or roots of a plant due to dissolution of the salt by contact of water vapor from transpiration of the plant.

In yet another aspect, the invention provides a method for increasing the bioactivity of a herbicide. The method comprises encapsulating the herbicide and a surfactant in a sol-gel microcapsule wherein the surfactant enhances the activity of the herbicide.

In still another aspect, the invention provides a method for increasing the bioactivity of a herbicide. The method comprises encapsulating the herbicide in a sol-gel microcapsule wherein the herbicide is a powder that is released on leaves, stems, flowers and/or roots of a plant due to the contact of water vapor from transpiration of the plant.

In yet another aspect, the invention provides a method for increasing the bioactivity of a herbicide. The method comprises encapsulating the herbicide in a sol-gel microcapsule wherein the shell of the microcapsule includes a salt, and the herbicide is released on leaves, stems, flowers and/or roots of a plant due to dissolution of the salt by contact of water vapor from transpiration of the plant.

In still another aspect, the invention provides a method for increasing the bioactivity of a herbicide. The method comprises encapsulating the herbicide in a sol-gel microcapsule; and coating the microcapsule with a polymer, wherein the herbicide is released on leaves, stems, flowers and/or roots of a plant due to dissolution of the polymer by contact of water vapor from transpiration of the plant.

In yet another aspect, the invention provides a method for increasing the bioactivity of a herbicide. The method comprises encapsulating the herbicide in a sol-gel microcapsule in the presence of a cationic agent. The cationic agent can comprise a cationic polymer.

These and other features, aspects, and advantages of the present invention will become better understood upon consideration of the following detailed description, drawings and appended claims.

### DETAILED DESCRIPTION OF THE INVENTION

The present invention encompasses compositions containing one or more herbicides that can be active ingredients that may be added to a highly charged sol-gel microcapsule containing composition. The herbicidal compositions generally comprise a herbicidal active ingredient within the highly charged microcapsule. Generally, the herbicidal active ingredient must leave the microcapsule in order to perform its action. In some embodiments, the capsules are produced such that the capsules rupture in order to release the herbicidal active ingredient. A cationic component can act to facilitate the controlled breakage of the capsules. In some cases, the plant surface onto which the capsules are applied is pre-coated with an agent that reacts with the sol-gel capsule in order to cause controlled breakage of the capsules and release of the herbicidal active ingredient. In some cases, the surface can be post treated with a substance that either enhances or retards capsule breakage. The invention further encompasses methods of use and manufacture of the compositions.

The sol-gel capsules of the invention can be formulated to control whether or not there is penetration into the plant surface and if there is penetration, to what depth. In some embodiments, the additive penetrates to an average of at least about 10, 15, 20, 25, 30, 40, 50, 60, 70, 80, 90, 100, 120, or 150 microns beneath the plant surface. In some embodiments, the additive penetrates to an average of no more than about 50, 40, 30, 25, 20, 15, 10, or 5 microns beneath the plant surface.

The herbicidal compositions of the invention may further include one or more components to provide a positive charge to the system to assist with attachment to plant surfaces, e.g., cationic polymeric agents. The cationic polymer may be, for example, a quaternium, e.g., polyquaternium.

The additives can be used for agricultural applications including agents to improve plant growth, nutrients, fertilizers, hygroscopic agents, and pesticides. Agricultural pesticides include agricultural fungicides, herbicides, insecticides and miticides. An agricultural fungicide generally refers to a compound capable of inhibiting the growth of or controlling the growth of fungi in an agricultural application, such as treatment of plants and soil; “herbicide” refers to a compound capable of inhibiting the growth of or controlling the growth of certain plants; “insecticide” refers to a compound capable of controlling insects; and “miticide” refers to a compound capable of controlling mites. Additives for agricultural applications include either topical applications such as leaf, stem, root, or trunk of trees and or applications surrounding plants or trees for uptake. Applications can also include addition to algae, fungi, bacteria, viruses or parasites on any substrate or in any environment these organisms are found.

The actives used in the invention may be encapsulated. Any means of encapsulation known in the art, including but not limited to liposomes, maltodextrin capsules, silica gels, siloxanes, and the like, may be used in the compositions of the invention. The actives of the invention can, for example, be encapsulated within microcapsules. Microcapsules can be viewed as having two parts, the core and the shell. The core contains the active ingredient, while the shell surrounds and protects the core. The core materials used in the invention can be solid or liquid, and if liquid, can be, for example, in the form of a pure compound, solution, dispersion or emulsion. The shell material can be a natural or synthetic polymer material or can be an inorganic material, such as a silica-based shell. The shell can be made permeable, semi-permeable or impermeable. Permeable and semi-permeable shells can be used for release applications. Semi-permeable capsules can be made to be impermeable to the core material but permeable to low molecular-weight liquids and can be used to absorb substances from the environment and to release them again when brought into another medium. The impermeable shell encloses the core material. To release the content of the core material the shell must be ruptured.

Microencapsulation useful in the present invention is described, for example, in Ghosh, K., Functional Coatings and Microencapsulation: A General Perspective, Wiley-VCH, Weinheim, 2006, Benita, S., Microencapsulation: Methods and Industrial applications, Marcel Dekker, Inc., NY, 1996., and Arshady, R., Microspheres, Microcapsules and Liposomes, Citrus Books, London, 1999.

The present invention can also incorporate mesoporous shells. The synthesis of mesoporous hollow spheres is described in Yeh et al., Langmuir, 2006, 22, 6, and in U.S. Pat. No. 6,913,825.

The encapsulated actives of the present invention can be made by chemical, physico-chemical, and physico-mechanical methods such as suspension, dispersion and emulsion, coacervation, layer-by-layer polymerization (L-B-L) assembly, sol-gel encapsulation, supercritical CO₂-assisted microencapsulation, spray-drying, multiple nozzle spraying, fluid-bed coating, polycondensation, centrifugal techniques, vacuum encapsulation, and electrostatic encapsulation.

In some embodiments, the active is encapsulated sol-gel microcapsules, such as silica sol-gel microcapsules. Such microcapsules are described in U.S. Pat. Nos. 6,238,650; 6,436,375, 6,303,149; 6,468,509, and in U.S. Patent Application Publication No. 2005/0123611. Thus, in some embodiments the invention provides an encapsulated herbicidal active ingredient and optionally further comprises a cationic polymer.

The sol-gel process can produce particles with a ceramic shell. The shells are prepared by a sol-gel based process in which partly hydrolyzed oxides of suitable metals are prepared in the presence of an active material by hydrolysis of the gel precursor followed by condensation (alternatively referred to as polycondensation). The gel precursor may be, for example, a metal oxide gel precursor including silicon oxide gel precursor or a transition metal oxide precursor. The type of gel precursor used will depend on the intended use of the ceramic particles. The gel precursor is typically a silica-based gel precursor, an alumina-based gel precursor, a titanium dioxide-based gel precursor, an iron oxide based gel precursor, a zirconium dioxide-based gel precursor or any combination thereof. A functionalized, derivatized or partially hydrolyzed gel precursor may also be used.

There are many silicon precursors which can used in the present invention. For convenience, they can be divided into four categories, the silicates (silicon acetate, silicic acid or salts thereof) the silsequioxanes and poly-silsequioxanes, the silicon alkoxides (e.g. from silicon methoxide to silicon octadecyloxide), and functionalized alkoxides for ORMOCER (Organically Modified Ceramics) production (such as ethyltrimethoxysilane, aminopropyltriethoxysilane, vinyltrimethoxysilane, diethyldiethoxysilane, diphenyldiethoxysilane, etc). Further specific examples of silica-based gel precursors include tetramethoxysilane (TMOS), tetraethoxysilane (TEOS), tetrabutoxysilane (TBOS), tetrapropoxysilane (TPOS), polydiethoxysilane, methyltrimethoxysilane, methyltriethoxysilane, ethyltriethoxysilane, octylpolysilsesquioxane and hexylpolysilsesquioxane. In some embodiments, the silica based precursors of the present invention are TEOS and TMOS.

Non-limiting examples of alumina-based gel precursors include aluminum ethoxide, aluminum n- or iso-propoxide, aluminum n- or sec- or tert-butoxide. The alkoxide can also be modified using carboxylic acids (for example, acetic, methacrylic, 2-ethylhexanoic acid) or beta di-ketones such as acetylacetone, ethyl-acetylacetone, benzoylacetone, or other complexing agent.

Non-limiting examples of titanium or zirconium gel precursors include the alkoxides (e.g. ethoxide, propoxide, butoxide), the metal salts (e.g. chloride, oxychloride, sulfate, nitrate) and the acid and beta diketone complexes.

The silica gel precursor or the metal oxide gel precursor may include, for example, from one to four alkoxide groups each having from 1 or more oxygen atoms, and from 1 to 18 carbon atoms, more typically from 1 to 5 carbon atoms. The alkoxide groups may be replaced by one or more suitable modifying groups or functionalized or derivatized by one or more suitable derivatizing groups (see K. Tsuru et al., J. Material Sci. Mater. Medicine, 1997, 8). Typically, the silica gel precursor is a silicon alkoxide or a silicon alkyl alkoxide.

Particular examples of suitable silicon alkoxide precursors include such as methoxide, ethoxide, iso-propoxide, butoxide and pentyl oxide. Particular examples of suitable silicon or metal alkyl (or phenyl) alkoxide precursors include methyl trimethoxysilane, di-methyldimethoxysilane, ethyltriethoxysilane, diethyldiethoxysilane, triethyl-methoxysilane, phenyltriethoxysilane, diphenyldiethoxysilane, vinyltriethoxysilane, etc. Alternatively, the silica gel precursor may be a silicon carboxylate. For example, an acetate, tartrate, oxalate, lactate, propylate, formate, or citrate. Examples of other functional groups attached to silica gel precursors include esters, alkylamines and amides.

Typically, the metal oxide gel precursor is a metal alkoxide which may be derivatised or functionalized. Examples of suitable metal oxide precursors include alkoxides such as methoxide, ethoxide, iso-propoxide, butyloxide and pentyl oxide. Alternatively, metal oxide gel precursor may be a metal carboxylate or a metal beta-diketonate, for example, an acetate, tartrate, oxalate, lactate, propylate, formate, citrate, or acetylacetonate. Examples of other functional groups attached to metal oxide precursors include esters, alkylamines and amides. More than one type of metal ion may be present.

Sol-gel processing is based on the hydrolysis and condensation of appropriate precursors. Water is thus typically used as the condensing agent.

The sol-gel process is carried out in the presence of a surfactant. Suitable surfactants may have a hydrophilic head group and a hydrophilic tail group. Non-limiting examples of hydrophilic head groups are sorbitan, polyether, polyoxyethylene, sulfosuccinate, phosphate, carboxylate, sulfate, amino or acetylacetonate and a hydrophobic tail group. The tail group may be, for example, straight or branched chain hydrocarbons with from about 8 to 24 carbon atoms, or from about 12 to 18 carbon atoms. The tail group may contain aromatic moieties such as for example iso-octylphenyl. The surfactants can be nonionic, cationic, or anionic. Ionic surfactants such as cationic surfactants can be used to impart a charge to the sol-gel capsules alone or in combination with cationic polymers to produce highly charged sol-gel microcapsules. Other suitable surfactants are described in detail below.

Microcapsules of the present invention can have a positive charge density. The microcapsules of the present invention can have a positive charge. The positive charge can, for example, can impart improved emulsion stability and improve adhesion to the plant surface. While not being bound by theory, one framework commonly employed in the area of colloid sciences is the DLVO theory, which states that the stability of a particle in solution is dependent upon its total potential energy function, V_{T}. The theory recognizes that V_{T} is the balance of several competing contributions: the potential energy due to solvent, Vₛ, the potential energy due to attraction, V_{A}, and the potential energy due to repulsion, V_{R}. The potential energy due to repulsion, V_{R}, is an important contributor to the stability of the colloid. One aspect of V_{R} is the electrostatic repulsion, which is related to the square of the zeta potential. The zeta potential can be described in the following manner. Each particle has a liquid layer around it that can be viewed as existing as two parts; an inner region (Stern layer) where the ions are strongly bound and an outer (diffuse) region where they are less firmly associated. This system is referred to as the double layer. Within the diffuse layer there is a notional boundary inside which the ions and particles form a stable entity. When a particle moves, ions within the boundary move it. Those ions beyond the boundary stay with the bulk dispersant. The potential at this boundary (surface of hydrodynamic shear) is the zeta potential. Because the electrostatic repulsion of the repulsion potential, V_{R} is related to the square of the zeta potential, as the square of the zeta potential rises, the electrostatic repulsion rises, and the stability of the colloid rises. The positively charged microcapsules of the present invention thus exhibit stability in solution, while at the same time, potentially providing enhanced binding to the surface.

Zeta potential can be calculated using theoretical models and an experimentally-determined electrophoretic mobility or dynamic electrophoretic mobility. Electrokinetic phenomena and electroacoustic phenomena are the usual sources of data for calculation of zeta potential. For example, electrophoresis is used for estimating zeta potential of particulates. Electrophoretic velocity is generally proportional to electrophoretic mobility, which is the measurable parameter. There are several theories that link electrophoretic mobility with zeta potential (see, for example, Lyklema, J. “Fundamentals of Interface and Colloid Science”, vol. 2, page. 3.208, 1995; and Hunter, R. J. “Foundations of Colloid Science”, Oxford University Press, 1989). Zeta potential can be determined, for example using microelectrophoresis or electrophoretic light scattering. With microelectrophoresis, images of the moving particles are used. In some cases, this method can be complicated by electro-osmosis at the walls of the sample cell.

Electrophoretic light scattering is based on dynamic light scattering. It allows measurement in an open cell, which eliminates the problem of electro-osmotic flow. Both these measuring techniques generally require dilution of the sample. Dilution is usually performed using equilibrium supernatant solution to minimize the effect of dilution on the zeta potential. In some cases, zeta potential can be measured electroacoustically. For example, the techniques of Colloid Vibration Current and Electric Sonic Amplitude can be used, (Dukhin, A. S, and Goetz, P. J. “Ultrasound for characterizing colloids”, Elsevier, 2002. reference). In some cases, the measurement of zeta potential provides a distribution of zeta potentials for the particles in the sample. In other cases, the methods provide a single zeta potential for the sample. Generally herein, where a reference to a zeta potential for a sample is described, it represents either the single measurement for the sample, or the mean, median or average of the distribution. In some cases the median value of the distribution of zeta potentials is used.

The zeta potential can be measured for instance on a Zetasizer instrument from Malvern Instruments, Malvern, UK, or on a ZetaPlus or ZetaPALS instrument from Brookhaven Instruments, Holtsville, N.Y.

In some embodiments, the microcapsules of the present invention have a zeta potential of at least about 5, 10, 12, 14, 16, 18, 20, 25, 30, 35, 40, 45, 50, 55, 60, 65, 70, 80, 90 or 100 mV. In some embodiments, the microcapsules of the present invention have a zeta potential of no more than about 15, 20, 25, 30, 35, 40, 45, 50, 55, 60, 65, 70, 80, 90, 100, 150, 200, 300, 400 or 500 mV. In some embodiments the zeta potential is between 10 and 70 mV, between 20 and 65 mV, between 25 and 65 mV, between 30 and 60 mV, between 30 and 100 mV, between 40 and 80 mV, between 70 and 100 mV or between 40 and 55 mV. In some embodiments, the microcapsules have a zeta potential of at least about 70 mV, in some embodiments, the microcapsules have a zeta potential of at least about 60 mV, in some embodiments, the microcapsules have a zeta potential of at least about 50 mV, in some embodiments, the microcapsules have a zeta potential of at least about 45 mV, in some embodiments, the microcapsules have a zeta potential of at least about 35 mV, in some embodiments, the microcapsules have a zeta potential of at least about 25 mV in some embodiments, the microcapsules have a zeta potential of at least about 15 mV.

The microcapsules of the present invention are usually dispersed in water or in an aqueous medium. The aqueous medium may contain salts, surfactants, viscosity modifiers, film formers, and other additives that may affect the zeta potential of the particles. It is known, for example that the zeta potential of a particle can be affected by the pH of the medium. The pH of the medium will have a particularly large effect on the zeta potential of a microcapsule when the microcapsule has ionizable, e.g. acidic or basic groups on its surface. For instance, where the microcapsule has a neutral acidic group, such as a carboxylic acid, that gives up a positively charged proton to the solution, the loss of the positively charged proton to the solution can give rise to one negative charge on the microcapsule surface. Conversely, a microcapsule surface with a neutral basic entity such as a trial kylamine, can become protonated in acidic solution, thus causing the microcapsule to take on a positive charge for each proton added. In both cases, the magnitude of the surface charge depends on the acidic or basic strengths of the surface groups and on the pH of the solution. In aqueous media, where the microcapsule has ionizable groups, the pH of the solution can have a dramatic affect on its zeta potential. For example, a microcapsule with ionizable carboxylic acid groups on the surface will have a negative zeta potential at high pH (basic conditions). If acid is added to this suspension then solution becomes more acidic, and the microcapsules tend to lose their negative charge. If enough acid is added to this suspension then a point will be reached where the charge will be neutralized. Where all of the charge is neutralized, there can be a point where microcapsules have zero zeta potential. This point is called the isoelectric point. The isoelectric point is normally the point where the colloidal system is least stable. Further addition of acid may cause a build up of positive charge on the microcapsules. Therefore a zeta potential versus pH curve will generally be positive at low pH and lower or negative at high pH

One aspect of the present invention is encapsulated actives wherein the capsules are positively charged at the pH at which the encapsulated additives are stored and applied. It will be understood by those skilled in the art that for plant applications, the compositions of the present invention will generally not be extremely acidic or extremely basic, because such solutions could be damaging to plant tissue. Thus, the compositions of the present invention are formulated to have capsules of the desired zeta potential in the pH range of use.

The compounds of the present invention can also use buffered systems. Buffered systems use combinations of acidic and basic species in order to create a solution that has a pH which is less sensitive to the loss or addition of acidic or basic species. The buffered systems are used to stabilize the pH of the composition.

The capsules of the present invention will often have more than one acidic or basic group associated with the surface of the particle. For instance the particle may have a sol-gel coating, surfactants, and cationic components, each of which may have ionizable, acidic, or basic groups. The acidity of a group is can be represented by the pKa of the group. Under ideal conditions, the pKa is the pH at which the functional group is equally in its protonated and non-protonated forms. At a pH above the pKa most groups will be non-protonated. At a pH below the pKa, most of the groups will be protonated. Thus, where there are a variety of functional groups, each of these groups on the surface of the microcapsule that had a different pKa would give rise to a different zeta potential versus different pH response. The zeta potential on the capsule will be a composite of the zeta potentials that would be provided by each of these groups individually at any given pH. It would be understood by one skilled in the art to use compositions and processes in order to provide the relative amount of each of these groups to provide the desired zeta potential at the desired pH range of the composition.

The zeta potential can also be affected by the level of other salts in solution, also referred to as the ionic strength. In general, the higher the ionic strength, the more compressed is the double layer. The type of ion in solution can also affect the zeta potential. For example, multivalent ions will normally compress the double layer more than monovalent ions. As would be appreciated by one of skill in the art, the number and type of ion in the compositions of the present invention can be modified in order to produce the highly charged sol-gel microcapsules of the present invention.

One aspect of the invention is the use of non-ionizable cationic agents to create a positively charged microcapsule. For example, a quaternary ammonium functional group, such as that present in the polyquaterniums has nitrogen molecules which have four alkyl groups covalently attached. The positively charged nitrogen atoms have no protons to donate and no lone pairs are present to accept protons. This results in a positive charge on these molecules over a wide pH range. These groups are charged, but are thus considered neither acidic nor basic in the pH ranges useful in topical applications. Since the groups are neither acidic nor basic, they tend to provide microcapsules with a zeta potential which is less sensitive to changes in pH than for a microcapsule with a positively charged ionizable group. Having a zeta potential which is less sensitive to pH can be useful in providing freedom to formulate the compound containing the microcapsules, and for maintaining stability when the compound is exposed to conditions which might affect its pH.

In some embodiments wherein encapsulation, e.g., sol-gel microencapsulation, is utilized, the composition of the microcapsule, e.g., sol-gel microcapsule, may be varied so as to allow for varying amounts of the active within the microcapsule to be released. The microcapsules, e.g., sol-gel microcapsules, can be prepared so as to experience minimal or no breakage when applied to a plant. Alternatively, the microcapsules, e.g., sol-gel microcapsules, can be prepared so as to experience various degrees of breakage, on average, when applied to the plant and when left on the plant. Thus, the microcapsules, e.g., sol-gel microcapsules, may be prepared so as to experience about 0% breakage, or breakage in a range from about 0.1, 0.5, 1, 2, 5, 10, 20, 30, 40, 50, 60, 70, 80, or 90% to about 0.5, 1, 2, 5, 10, 20, 30, 40, 50, 60, 70, 80, or 90%, after application. Furthermore, the microcapsules may be formulated so as to break open in response to conditions that occur on the plant, so that after application the microcapsules act to release their contents in a time-release or controlled manner. Non-limiting exemplary plant conditions that can vary with the environment, the variation of which can trigger breakage of microcapsules, include pH, temperature, friction, exposure to light or air, pressure, enzymes, and the like.

In some cases the capsules are designed to break open and release their contents within a short period of time of contacting the plant. One way of controlling whether the microcapsules will tend to break is by controlling the conditions of manufacture including the temperature and the shear during mixing. In some cases, polymer wrapped or polymer coated microcapsules such as silica microcapsules will be able to stand higher salt concentrations and alkaline pH. The polymeric coatings are believed to assist in controlling breaking both by acting as a chemical barrier between the silica and the environment and also by providing more mechanical strength and elasticity.

The tendency of a microcapsule to break under shear can be measured by exposing the compound containing microcapsules to a set of conditions of shear (e.g. by controlling the RPM of stirring), temperature, and time, and analyzing the resulting mixture or aliquot of the mixture. The mixture can be analyzed, for example, by analyzing the solution in which the microcapsules are dispersed by high performance liquid chromatography (HPLC), which can be used to determine the amount of active or other component that has gone into the solution.

One aspect of the invention is a composition with containing a cationic agent. In some embodiments the cationic agent is added to the herbicidal active ingredient, imparting beneficial properties such as promoting attachment of the herbicidal active ingredient to a plant. In other embodiments the cationic agent is associated with the microcapsule, providing positive charge to the microcapsule. In some embodiments the herbicidal active ingredient includes a cationic component. Without being bound by theory, it is thought that this component serves as a protein binder, to provide a positive charge to promote attachment of the composition to a plant, thus increasing retention of the components, e.g., herbicidal active ingredient, after rinse and during normal activities. This positive charge can create a strong affinity for the plant. As described above, the cationic component can also create a positive charge on the surface of a microcapsule so as to stabilize the composition. Any means of imparting a positive charge to the microcapsule may be used.

In some embodiments any suitable cationic compound that may be useful to impart a positive charge on the microcapsule may be used.

In some embodiments, one or more cationic polymers are included in the composition. The term polymer means many “mers” or units. As used herein, the term polymer means a molecule having two or more repeating units. Various cationic polymers may be used. Examples of cationic polymers are described in U.S. Pat. Nos. 6,224,852; 3,816,616; 4,272,515; 4,298,494; 4,080,310; 4,048,301; 4,009,256; and 3,186,911. Cationic polymers are available commercially, e.g., from Union Carbide Corp. under the trademark POLYMER JR., from Celanese-Stein Hall under the trademark JAGUAR, from GAF Corporation under the tradename Gafquatm and from Merck & Co., Inc under the trademark MERQUAT. Representative ones are Merquat 100, a highly charged cationic dimethyldiallylammonium chloride homopolymer, and Merquat 550, a highly charged cationic copolymer prepared with dimethyldiallylammonium chloride and acrylamide. These materials are designated in the CTFA dictionary as Quaternium40 and Quaternium-41, respectively.

Suitable cationic polymers include Polyquaternium-4 (Celquat H-100; L200-supplier National Starch); Polyquaternium-7; Polyquaternium-10 (Celquat SC-240C; SC-230 M-supplier National Starch); (UCARE polymer series-JR-125, JR-400, LR-400, LR-30M, LK, supplier Amerchol); Polyquaternium-11 (Gafquat 734; 755N-supplier ISP); Polyquaternium-16 (Luviquat FC 370; FC550; FC905; HM-552 supplier by BASF); Polyquatemium-22, Polyquaternium-37, Polyquaternium-44, Polyquaternium-51, and Polyquaternium-64. PVP/Dimethylaminoethylmethacrylate (Copolymer 845; 937; 958-ISP supplier); Vinyl

Caprolactam/PVP/Dimethylaminoethyl Methacrylate copolymer (Gaffix VC-713; H2OLD EP-1-supplier ISP); Chitosan (Kytamer L; Kytamer PC-supplier Amerchol); Polyquatemium-7 (Merquat 550-supplier Calgon); Polyquaternium-18 (Mirapol AZ-1 supplied by Rhone-Poulenc); Polyquaternium-24 (Quatrisoft Polymer LM-200-supplier Amerchol); Polyquaternium-28 (Gafquat HS-100-supplier ISP); Polyquaternium-46 (Luviquat Hold-supplier BASF); and Chitosan Glycolate (Hydagen CMF; CMFP-supplier Henkel); Hydroxyethyl Cetyldimonium Phosphate (Luviquat Mono CP-supplier BASF); and Guar Hydroxylpropyl Trimonium Chloride (Jaguar C series-13S, -14S, -17, 162, -2000, H1-CARE 1000-supplier Rhone-Poulenc).

Suitable cationic polymers also include Chitosan (Chitosan); Guar Hydroxypropyltrimonium Chloride (Guar Hydroxypropyltrimonium Chloride); Hydroxypropyl Guar Hydroxypropyltrimonium Chloride; Poly(Ethylenimine) (PEI-7 PEI-10 PEI-1500 . . . PEI-7500 PEI-14M); Poly(Methacrylamidopropyltrimonium Chloride/Methosulfate) (Polymethacrylamidopropyltrimonium Chloride); (Polyquaternium-2); Co(Hydroxyethylcellulose-g-Diallyldimethyl Ammonium Chloride) (Polyquaternium-4); Poly(Diallyldimethyl Ammonium Chloride) (Polyquaternium-6); Co(Diallyldimethyl Ammonium Chloride-Acrylamide) (Polyquaternium-7); Hydroxypropyltrimonium Hydroxyethylcellulose Chloride (Polyquatemium-10); Quaternized Co(Vinyl Pyrrolidone-Dimethylaminoethyl Methacrylate) (Polyquaternium-11); Co(Diallyldimethyl Ammonium Chloride-Acrylic Acid) (Polyquaternium-22); Hydroxypropyllauryldimonium Hydroxyethylcellulose Chloride (Polyquatemium-24); Co(Vinyl Pyrrolidone-Methacrylamidopropyl Trimethylammonium Chloride) (Polyquaternium-28); Co(Diallyldimethyl Ammonium Chloride-Acrylic Acid-Acrylamide) (Polyquaternium-39); Co(Vinyl Caprolactam-Vinyl Pyrrolidone-N-Vinyl-N-Methyl Imidazolinium Methosulfate) (Polyquaternium-46); Co(Vinyl Pyrrolidone-Dimethylaminopropyl Methacrylamide-Lauryl Dimethyl Methacrylamidopropyl Ammonium Chloride) (Polyquaternium-55); Co(Vinylpyrrolidone-Dimethylaminoethylmethacrylate)/Polycarbamyl Polyglycol Ester (PVP/Dimethylaminoethylmethacrylate/Polycarbamyl Polyglycol Ester); Co(Vinyl Pyrrolidone-Dimethylaminopropyl Methacrylamide) (PVP/DMAPA Copolymer); Co(Vinyl Pyrrolidone-Dimethylaminoethyl Methacrylate) (Vinyl Pyrrolidone/Dimethylaminoethylmethacrylate Copolymer); Co(Vinyl Pyrrolidone-Vinyl Caprolactam-Dimethylaminoethylmethacrylate) (Vinyl Pyrrolidone/Vinyl Caprolactam/Dimethylaminoethylmethacrylate Terpolymer); Co(Vinyl Pyrrolidone-Vinyl Caprolactam-Dimethylaminopropylmethacrylamide (Vinyl Pyrrolidone/Vinyl Caprolactam/Dimethylaminopropylmethacrylamide Terpolymer); Co(Vinyl Pyrrolidone-Vinyl imidazole) (Vinyl Pyrrolidone/Vinyl Imidazole Copolymer); and Co(Vinyl Pyrrolidone-3-methyl-1-Vinylimidazolinium methyl sulfate) (Vinyl Pyrrolidone/Vinylimidazolinium Methylsulfate Copolymer).

Some embodiments employ polyquaterniums. Quaternized material in powder form, not limited to the polyquaterniums, may also be used. Exemplary polyquaterniums of use in the invention include Polyquaternium-4, -7, -11, -22, -37, -44, -51, and -64. Without being limited by theory, it is believed that with the trapping of the encapsulate (e.g., herbicidal active ingredient inside the capsule) by the cationic component increases adhesion to the plant. In other embodiments, other polyquaterniums may be useful for imparting a positive charge on the microcapsules.

Mixtures of the cationic components can be used. Uses of mixtures of cationic components can be made to increase solubility, improve processing, and to improve the properties of the compound, for example, enhancing adhesion to the plant. Mixtures of different polyquaterniums can be used, for example, polyquaterniums with different molecular weight ranges, and mixtures of polyquaterniums and non-polyquaterniums can be used.

In some embodiments cationic surfactants can be used to impart a positive charge on the microcapsules. Cationic surfactants useful in the invention are described below. While the cationic component should be cationic over all, the cationic component may also contain some anionic groups as well, and may be, for example amphoteric.

Useful in some embodiments of the invention is a dry cationic component, such as sold under the tradename CAE (Anjinomoto Co., Inc.), containing DL-pyrrolidone Carboxylic acid salt of L-Cocoyl Arginine Ethyl Ester, which is a cationic agent useful for binding to proteins and providing an antimicrobial effect.

In some embodiments, as an additive, the cationic component comprises about 0.1 to about 20%, or about 0.1 to about 10%, or about 0.5 to about 10%, or about 1 to about 10%, or about 0.5 to about 5%, or about 0.5 to about 3% or about 1 to about 5%, or about 1 to about 3%, or about 1% of the total composition. In some embodiments, the cationic component includes polyquatemium-4; in some embodiments the polyquaternium-4 is present at about 1%.

In some embodiments, the cationic component (e.g., cationic polymer) comprises about 0.03 to about 7%, or about 0.03 to about 4%, or about 0.2 to about 4%, or about 0.3 to about 4%, or about 0.2 to about 2%, or about 0.3 to about 4%, or about 0.3 to about 1%, or about 0.3 or 0.4% of the total composition. In some embodiments, the cationic component is polyquaternium-4; in some embodiments the polyquaternium-4 is present at about 0.33%.

In some embodiments, the cationic compound may be associated with the microcapsule in any suitable manner. In some embodiments the cationic compound is associated with the outside of the highly charged microcapsule. The cationic compound may be covalently bound to the microcapsule, may be bound non-covalently, or may exhibit a mixture of covalent and non-covalent binding. Non-limiting examples of types non-covalent interactions between the cationic compound and the microcapsule are those due to electrostatic, hydrogen bonds, hydrophobic, or Van Der Waals forces.

In some embodiments, it is desired to have a herbicidal active ingredient contained within a microcapsule, while at the same time, providing another herbicidal active ingredient outside the capsule, in the continuous phase of the composition.

The compositions of the invention may be prepared by any suitable method. The encapsulated actives of the present invention can be made by chemical, physico-chemical, and physico-mechanical methods such as suspension, dispersion and emulsion, coacervation, layer-by-layer polymerization (L-B-L) assembly, sol-gel encapsulation, supercritical CO₂-assisted microencapsulation, spray-drying, multiple nozzle spraying, fluid-bed coating, polycondensation, centrifugal techniques, vacuum encapsulation, and electrostatic encapsulation.

Microencapsulation methods useful in the present invention is described, for example, in Ghosh, K., Functional Coatings and Microencapsulation: A General Perspective, Wiley-VCH, Weinheim, 2006, Benita, S., Microencapsulation: Methods and Industrial applications, Marcel Dekker, Inc., NY, 1996., Arshady, R., Microspheres, Microcapsules and Liposomes, Citrus Books, London, 1999, and Boissiere et al. J. Mater. Chem., 2006, 16, 1178.

The sol-gel microcapsules of the invention can be formed, for example, by using techniques described in U.S. Pat. Nos. 6,238,650; 6,436,375, 6,303,149; 6,468,509, and U.S. Patent Application No. 2005/0123611. In order to form highly charged microcapsules, a cationic agent may be incorporated into the microcapsule or become associated with the microcapsule. The cationic agent can, for example, be a cationic surfactant, a cationic polymer, or a both a cationic surfactant and a cationic polymer. The process for forming the microcapsules of the present invention generally involves mixing a gel precursor, an active ingredient, and a surfactant to form a mixture, emulsifying the mixture in an aqueous medium such that the gel precursor hydrolyzes to form a sol-gel ceramic microcapsule, resulting in at least a portion of the additive encapsulated within the microcapsule, and adding a cationic agent to impart a high zeta potential to the microcapsules. At least some of the cationic agent can be added prior to the formation of microcapsules. For instance, a cationic surfactant can be used in the initial formation stage in order to impart some charge. The cationic agent can also be incorporated after the formation of the microcapsules. For instance, a cationic polymer can be added to the solution containing the formed microcapsules containing the active ingredient. The cationic polymer, such as polyquaternium-4 can bind to the microcapsules, and/or become partially incorporated into the microcapsules, increasing the charge on the microcapsules.

One aspect of the invention comprises methods for preparation of highly charged sol-gel microcapsules comprising active ingredients. The methods include forming capsules using oil-in-water (O/W) emulsions, water-in-oil (W/O) emulsions, liposomes, micelles, and polymeric microspheres. The various methods allow for the encapsulation of any type of suitable ingredient, for example, those described herein. For example, an oil-in-water emulsion can be used for incorporating a non-polar herbicidal active ingredient, where the non-polar active ingredient either comprises substantially all of the oil phase, or the non-polar active ingredient is mixed with other non-polar components, either active or inert. The non-polar components comprise the “oil” phase of the water-in-oil emulsion. The oil phase constitutes generally spheroidal liquid particles or droplets dispersed in the continuous aqueous phase. Hydrolysis of the gel precursor material produces a sol-gel capsule which is formed around the non-polar components. The highly charged capsules are formed by incorporating a cationic agent into the capsules. In some embodiments, the cationic agent is added prior to formation of the sol-gel capsules. In some embodiments, the cationic agent is added during the formation of the sol-gel capsules. In some embodiments, the cationic agent is added after the formation of the sol-gel capsules.

One aspect of the invention comprises a method of manufacturing a highly charged sol-gel microcapsule comprising a non-polar herbicidal active ingredient comprising: (a) combining the non-polar herbicidal active ingredient, optional non-polar diluent, and aqueous phase; (b) agitating the combination formed in (a) to form an oil-in-water (O/W) emulsion wherein the non-polar herbicidal active ingredient and optional non-polar diluent comprise the dispersed phase; (c) adding one or more surfactants; (d) adding a cationic agent; (e) adding a gel precursor to the O/W emulsion; and (f) mixing the composition from step (e) while the gel precursor hydrolyzes and sol-gel capsules are formed which comprise the non-polar herbicidal active ingredient.

A water-in-oil emulsion provides for the encapsulation of polar and aqueous soluble herbicidal active ingredients. In the water-in-oil method, the active ingredient or ingredients and optional polar diluent are dissolved or dispersed in an aqueous phase. A water-in-oil emulsion is formed, wherein the aqueous liquid particles or droplets are dispersed within a non-polar, aqueous immiscible “oil” phase. Hydrolysis of the gel precursor material produces a sol-gel capsule which is formed around the non-polar component. In some embodiments, the cationic agent is added prior to formation of the sol-gel capsules. In some embodiments, the cationic agent is added during the formation of the sol-gel capsules. In some embodiments, the cationic agent is added after the formation of the sol-gel capsules.

One aspect of the invention is a method of manufacturing a highly charged sol gel microcapsule comprising a polar herbicidal active ingredient comprising: (a) combining the polar herbicidal active ingredient, water, optional polar diluent, and a non-polar (oil) phase; (b) agitating the combination formed in (a) to form an water-in-oil (W/O) emulsion wherein the polar active ingredient, water, and optional polar diluent comprise the dispersed phase; (c) adding one or more surfactants; (d) adding a cationic agent; (e) adding a gel precursor to the W/O emulsion; and (f) mixing the composition from step (e) while the gel precursor hydrolyzes and sol-gel capsules are formed which comprise the polar active ingredient.

While we describe the invention with respect to the binary O/W or W/O, the methods of the invention can also be used in ternary, quaternary or higher emulsions such as W/O/W, O/W/O, W/O/W/O, etc.

The invention also provides for methods of forming highly charged sol-gel microcapsules using template within a solution, usually an aqueous solution. The template is generally structure dispersed within a continuous solution that comprises the herbicidal active ingredient. The template is generally spheroidal, need not be a spheroid, and can have an elongated or irregular shape or distribution of shapes. The template can be a polymer microsphere, liposome, or micelle. Hydrolysis of the gel precursor material produces a sol-gel capsule which is formed around the template. The highly charged capsules are formed by incorporating a cationic agent into the capsules. In some embodiments, the cationic agent is added prior to formation of the sol-gel capsules. In some embodiments, the cationic agent is added during the formation of the sol-gel capsules. In some embodiments, the cationic agent is added after the formation of the sol-gel capsules.

One aspect of the invention is a method of forming a highly charged sol-gel microcapsule comprising an herbicidal active ingredient within a template comprising: (a) forming a dispersion of templates, wherein the templates comprise a herbicidal active ingredient, in an aqueous continuous phase; (b) adding a cationic agent; (c) adding a gel precursor to the aqueous continuous phase; and (d) mixing the composition from step (c) while the gel precursor hydrolyzes and sol-gel capsules are formed.

A non-polar herbicidal active ingredient is generally an ingredient that is insoluble or sparingly soluble in water or in aqueous solution. The non-polar ingredient may be soluble in an oil such as mineral oil, palm oil, or silicone oil. It is understood in the art how to determine solubility in order to determine if a non-polar ingredient is suitable. In some embodiments, such as with the O/W method, the active ingredient or ingredients comprise the whole of the non-polar “oil” phase. In some embodiments of the O/W method, the non-polar active ingredients are dissolved or dispersed into an optional non-polar diluent. The non-polar diluent can be any suitable oil, wax, or solvent.

The non-polar phase can be dispersed within the aqueous phase by any suitable means. The dispersion of the non-polar phase in the aqueous phase is generally referred to as an emulsion. The formation of emulsions is known in the art. In some cases, a mixer, such as a mixer with a rotor-stator is used. Emulsions of the invention can also be formed using liquid jets, vibrating nozzles or other methods. The aqueous phase generally comprises at least 50% water. In some cases, the aqueous phase is substantially all water. In some cases, the aqueous phase comprises other co-solvents or other water soluble agents. Co-solvents, can be any water miscible solvent including, for example, methanol, ethanol, or ethylene glycol. The aqueous phase can also comprise other additives such as thickening agents, sugars, water soluble polymers, etc.

The oil-in-water emulsion or water-in-oil emulsion is generally stabilized using one or more surfactants. Suitable surfactants are described herein and known in the art.

In order to form the oil-in-water emulsion of the invention, surfactants with an HLB value above about 8 are generally used. In some cases, multiple surfactants are used. Where there are multiple surfactants, the combined HLB of the surfactants is generally used. The HLB of the surfactant or surfactants is between, for example, 7 and 13, 8 and 12, 9 and 11, 9.5 and 10.5. In some embodiments, the HLB of the surfactants is 8, 8.5, 9, 9.5, 10, 10.5, 11, 11.5 or 12.

In order to form the water-in-oil emulsion of the invention, surfactants with an HLB value below about 8 are generally used. In some cases, multiple surfactants are used. Where there are multiple surfactants, the combined HLB of the surfactants is generally used. The HLB of the surfactant or surfactants is between, for example, 2 and 7, 3 and 6, 4 and 5, or 3.5 and 4.5. In some embodiments, the HLB of the surfactants is 2, 2.5, 3, 3.5, 4, 4.5, 5, 5.5 or 6.

Suitable surfactants for forming the oil-in-water emulsion, water-in-oil emulsion, or template micelle include, for example, anionic, cationic, zwitterionic, semipolar, PEGylated, amine oxide and aminolipids. Suitable surfactants include: anionic-sodium oleate, sodium dodecyl sulfate, sodium diethylhexyl sulfosuccinate, sodium dimethylhexyl sulfosuccinate, sodium di-2-ethylacetate, sodium 2-ethylhexyl sulfate, sodium undecane-3-sulfate, sodium ethylphenylundecanoate, carboxylate soaps; cationic-dimethylammonium and trimethylammonium surfactants of chain length from 8 to 20 and with chloride, bromide or sulfate counterion, myristyl-gammapicolinium chloride and relatives with alkyl chain lengths from 8 to 18, benzalkonium benzoate, double-tailed quaternary ammonium surfactants with chain lengths between 8 and 18 carbons and bromide, chloride or sulfate counterions; nonionic: PEGylated surfactants of the form CₙEₘ where the alkane chain length n is from 6 to 20 carbons and the average number of ethylene oxide groups m is from 2 to 80, ethoxylated cholesterol; zwitterionics and semipolars-N,N,N-trimethylaminodecanoimide, amine oxide surfactants with alkyl chain length from 8 to 18 carbons; dodecyldimethylammoniopropane-1-sulfate, dodecyldimethylammoniobutyrate, dodecyltrimethylene di(ammonium chloride); decylmethylsulfonediimine; dimethyleicosylammoniohexanoate and relatives of these zwitterionics and semipolars with alkyl chain lengths from 8 to 20.

The cationic agent or cationic component used in the method to impart the high charge can be any suitable cationic agent described herein or known in the art including a cationic surfactant, a cationic polymer, or a both a cationic surfactant and a cationic polymer. The cationic polymer can comprise a polyquaternium, such as polyquatemium-4, -7, -11, -22, -27, -44, 51, or -64. In one exemplary embodiment, the cationic polymer is polyquaternium-4. In some embodiments, the cationic agent can also comprise a proton donor or Lewis acid.

The point in the process where the cationic agent is introduced into the reaction mixture can be important with respect to the production of highly charged sol-gel capsules. The point of addition will depend, for example, on the type of reaction conditions and the type of cationic agent or agents employed. In some embodiments, the cationic agent is added prior to the hydrolysis of the gel precursor. In these cases, the cationic agent will often be added just before, during, or just after the addition of the gel precursor.

In some cases, the cationic agent is added during the hydrolysis of the gel precursor and formation of the sol-gel capsule. While not being bound by theory, it is believed that the presence of the cationic agent or addition of the cationic agent during formation of the capsule can result in incorporation of the cationic agent into the wall of the capsule. It is believed that in some cases, this type of addition can result in improved stability of the cationic charge.

In some cases, the cationic agent is added subsequent to the formation of the capsule, thus providing a coating of the cationic agent onto the outside of the capsule. While not being bound by theory, it is believed that treatment of the capsules with the cationic agent subsequent to the formation of the sol-gel capsule can result in the cationic agent being concentrated on the outermost portion of the sol-gel capsule, which can provide a high amount of charge for a given amount of cationic agent.

The cationic agent can be added at more than one point in the process. In some cases, more than one cationic agent is used, each of which is added at a different point in the process. For example, in one embodiment a first cationic agent comprising, for example, a cationic surfactant is added before addition of the gel precursor, and during or subsequent to formation of the sol-gel capsules a second cationic agent, for example, a polymeric cationic agent such as a polyquaternium is added. In this manner the combination of cationic agents can act together to create the highly charged sol-gel capsules of the invention.

The gel precursor can be any suitable sol-gel forming material described herein or known in the art. The gel precursor can be, for example, a silica-based gel precursors include tetramethoxysilane (TMOS), tetraethoxysilane (TEOS), tetrabutoxysilane (TBOS), tetrapropoxysilane (TPOS), polydiethoxysilane, methyltrimethoxysilane, methyltriethoxysilane, ethyltriethoxysilane, octylpolysilsesquioxane and hexylpolysilsesquioxane. The gel precursor is added to the oil-in-water emulsion, and the pH is adjusted in order to cause the gel-precursor to hydrolyze and form the sol-gel capsule. The reaction is carried out with mixing at a rate such that the sol-gel reaction occurs at the interface between the oil and water, creating the sol-gel capsule. In some embodiments the pH is raised (made basic) in order to form the sol-gel capsule. In some embodiments, the pH is lowered (made acidic) in order to form the sol-gel capsule. In some embodiments, the pH is lowered to between 2 and 6, 3 and 5, 3 and 4, or 3.2 and 3.8. In some embodiments the pH is lowered to 2, 2.5, 3, 3.2, 3.3, 3.4, 3.5, 3.6, 3.7, 3.8, 3.9, 4.0, 4.2, 4.4, 4.6, 4.8, 5, 5.5, or 6. The hydrolysis of the gel precursor generally requires the presence of water. In the case of the oil-in-water emulsion, the water for hydrolysis can be provided from the continuous aqueous phase of the emulsion. In the case of the water-in-oil emulsion, the water can be provided as part of the polar dispersed phase, and/or water can be added to the reaction mixture after formation of the emulsion in order to facilitate hydrolysis.

The size of the sol gel capsules formed is determined, at least in part, by the conditions of the reaction including the size of the original emulsion, and the conditions used for formation of the sol-gel capsules. A distribution of capsule sizes is generally obtained. The sol-gel capsules can also be fractionated into a desired size range after capsule formation. Fractionation can be carried out by methods known in the art such as selective precipitation, or by using filters or sieves in order to pass a selected size range and retain the rest. The size of the sol-gel capsules can be modified in order to suit a particular application. In some embodiments, the mean, median, or average size of the capsules is between 10 nm and 1 mm, between 10 nm and 1 μm, between 1 μm and 100 μm, 10 μm and 50 μm, 50 μm and 200 μm, or between 200 μm and 500 μm. In some embodiments, the mean, median, or average size of the capsules is between 1 nm and 10 nm, 10 nm and 100 nm, 100 nm and 1 μm, 1 μm and 10 μm, 10 μm and 100 μm, 100 μm and 1 mm, 1 mm-10 mm, or larger. In some embodiments, the mean, median, or average size of the capsules is within plus or minus 10% of 1 nm, 10 nm, 25 nm, 50 nm, 75 nm, 90 mm, 100 nm, 250 nm, 500 nm, 750 nm, 900 nm, 1 μm, 10 μm, 25 μpm, 50 μm, 75 μpm, 90 μm, 100 μm, 250 μm, 500 μm, 750 μm, 900 μm, 1 mm or larger.

The sol gel capsules can be isolated from the reaction mixture, for example by filtration or precipitation. In addition to isolation of the capsules from the solution, these processes can affect the size distribution of the sol-gel capsules. The capsules can be filtered using standard filtration equipment. In some cases a vacuum or pressure is used to facilitate the filtration process. The capsules can then be rinsed to remove impurities from the reaction mixture including residual ethanol and/or unreacted gel precursor. The capsules can be rinsed with any suitable solvent. In some embodiments, the capsules are rinsed with water. The rinsing steps can also be used to add other components to the capsules. For example, a rinse using a solvent comprising a cationic component can result in increasing the charge on the microcapsules.

The sol-gel capsules of the present invention can be dried. In some cases, the dried sol-gel capsules have better shelf life stability than the wet capsules. In some cases, the dried capsules are more suitable for incorporation into a formulation, for example a non-polar formulation for products such as wash-on or leave-on products. Drying can be accomplished by any suitable means including passive exposure to heat and dry air or with spray-dry machinery. In some cases the capsules are dried at room temperature, in some cases the capsules are dried at between room temperature and 50° C.

The methods of the invention can produce highly charged microcapsules. One method for measuring the charge on the microcapsule is with zeta potential. The methods produce capsules having a zeta potential of at least 5, 10, 12, 14, 16, 18, 20, 25, 30, 35, 40, 45, 50, 55, 60, 65, 70, 80, 90 or 100 mV. In some embodiments, the microcapsules of the present invention have a zeta potential of no more than 15, 20, 25, 30, 35, 40, 45, 50, 55, 60, 65, 70, 80, 90, 100, 150, 200, 300, 400 or 500 mV. In some embodiments the zeta potential is between 10 and 70 mV, between 20 and 65 mV, between 25 and 65 mV, between 30 and 60 mV, between 30 and 100 mV, between 40 and 80 mV, between 70 and 100 mV or between 40 and 55 mV. In some embodiments, the microcapsules have a zeta potential of at least 70 mV, in some embodiments, the microcapsules have a zeta potential of at least 65 mV, in some embodiments, the microcapsules have a zeta potential of at least 60 mV, in some embodiments, the microcapsules have a zeta potential of at least 55 mV, in some embodiments, the microcapsules have a zeta potential of at least 50 mV, in some embodiments, the microcapsules have a zeta potential of at least 45 mV, in some embodiments, the microcapsules have a zeta potential of at least 35 mV, in some embodiments, the microcapsules have a zeta potential of at least 25 mV in some embodiments, the microcapsules have a zeta potential of at least 15 mV.

In one aspect of the invention, the methods of the invention produce capsules with a zeta potential that is higher than the zeta potential without the cationic agent. In some embodiments, the zeta potential of the capsule is 5%, 10%, 20%, 30%, 40%, 50%, 60%, 70%, 80%, 90%, or 1 times, 2 times, 3 times, 4 times, 5 times, 10 times, 20 times, 50 times, 100 times or more than the zeta potential of the capsule without the cationic agent. In some embodiments the zeta potential of the capsule is 5% to 10%, 10% to 20%, 20% to 50%, 50% to 90%, 1 to 2 times, 2 to 5 times, 5 to 10 times, 10 to 100 times or more than the zeta potential of the capsule without the cationic agent.

For the methods of the invention, in some cases, the steps are carried out in the order that they are listed. In some cases, where appropriate, the order of the steps can be different than the order listed

In the methods which utilize a template for the formation of a highly charged sol-gel microcapsule, the template is generally a microsphere, liposome or micelle. Where the template is a microsphere, it is generally a polymeric microsphere.

In some embodiments of the invention, the highly charged microcapsules of the invention may be prepared by mixing the microcapsule with a cationic compound to impart the high positive charge density onto the microcapsule.

In some embodiments, the cationic compound added to the microcapsule is a cationic polymer. The cationic polymer may be, for example, a polyquarternium. The polyquaternium may be, for example, polyquaternium-4.

In one embodiment, the cationic compound is associated with the outside of the highly charged microcapsule. In a further embodiment, the cationic compound is covalently bound to the microcapsule. In another embodiment, the cationic compound is noncovalently bound to the microcapsule. The interaction between the cationic compound and the microcapsule may be, for example, an electrostatic, ionic, or a Van Der Waals attraction.

In one non-limiting example version of the invention, an herbicidal composition is provided. In one form, the herbicidal active ingredient is N-phosphonomethylglycine, a polar, very broad spectrum, nonselective herbicide which has the common name of glyphosate. Glyphosate is an environmentally well tolerated and highly effective herbicide. It is typically applied as water-soluble salt, for example as alkali metal salt, ammonium salt, alkylamine salt, alkylsulfonium salt, alkylphosphonium salt, sulfonylamine salt or aminoguanidine salt or else as free acid in aqueous formulations, or else in solid form, to leaves and grasses, where it acts upon the transport system of the plants and destroys them. Some commercially available formulations of glyphosate contain glyphosate in the form of its isopropylamine salt in aqueous solution. In one example, the invention provides a method of manufacturing a highly charged sol gel microcapsule comprising a polar herbicidal active ingredient comprising: (a) combining the polar active ingredient (glyphosphate or a salt thereof), water and a non-polar (oil) phase; (b) agitating the combination formed in (a) to form an water-in-oil (W/O) emulsion wherein the polar active ingredient, water, and optional polar diluent comprise the dispersed phase; (c) adding one or more surfactants; (d) adding a cationic agent; (e) adding a gel precursor to the W/O emulsion; and (f) mixing the composition from step (e) while the gel precursor hydrolyzes and sol-gel capsules are formed which comprise the polar active ingredient.

In another non-limiting example version of the invention, an herbicidal composition is provided. In one form, the herbicidal active ingredient is atrazine (6-chloro-N₂-ethyl-N₄-isopropyl-1,3,5-triazone,4-diamine), a non-polar, photosynthetic inhibitor. One embodiment of the invention comprises a method of manufacturing a highly charged sol-gel microcapsule comprising a non-polar herbicidal active ingredient comprising: (a) combining the non-polar active ingredient (e.g. atrazine), optional non-polar diluent, and aqueous phase; (b) agitating the combination formed in (a) to form an oil-in-water (O/W) emulsion wherein the non-polar herbicidal active ingredient and optional non-polar diluent comprise the dispersed phase; (c) adding one or more surfactants; (d) adding a cationic agent; (e) adding a gel precursor to the O/W emulsion; and (f) mixing the composition from step (e) while the gel precursor hydrolyzes and sol-gel capsules are formed which comprise the non-polar active ingredient.

The herbicide used in the invention can be selected based on its mechanism of action. For example, the herbicide can be a photosynthetic inhibitor, a respiration inhibitor, a cell division inhibitor, a nucleic acid metabolism inhibitor, a protein synthesis inhibitor, or a membrane function inhibitor.

Thus, the invention provides a method for forming hollow silica-based particles suitable for containing one or more herbicidal active ingredients.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. A method for forming a herbicidal composition, the method comprising:
(a) preparing an emulsion including a continuous phase that is polar or non-polar, and a dispersed phase comprising droplets including (i) a polar herbicidal active ingredient when the continuous phase is non-polar or (ii) a non-polar herbicidal active ingredient when the continuous phase is polar; and
(b) adding a silica precursor to the emulsion such that the silica precursor can be emulsion templated on the droplets to form hollow silica-based particles that encapsulate the herbicidal active ingredient,
wherein the silica precursor has the general formula (I):
R¹_{x—Si—(OR}²)_{y} (I)
wherein R¹ is selected from substituted and unsubstituted alkyl, substituted and unsubstituted aryl, alcohols, amines, amides, aldehydes, acids, esters, and functional groups having an unsaturated carbon-carbon bond, R² is an alkyl group, x+y=4, and y=1, 2 or 3.

2. The method of claim 1 wherein:
the herbicidal active ingredient is selected from the group consisting of glyphosate, glyphosate salts, and mixtures thereof.

3. The method of claim 1 wherein:
the herbicidal active ingredient is associated with a shell of the particles,
the herbicidal active ingredient is a glyphosate salt, and
the glyphosate salt is released on leaves, stems, flowers and/or roots of a plant due to dissolution of the glyphosate salt by contact of water vapor from transpiration of the plant.

4. The method of claim 1 wherein:
step (a) comprises adding a surfactant selected from cationic, anionic, nonionic and amphoteric surfactants to a first material comprising the continuous phase and a second material comprising the dispersed phase to form the emulsion, and
the surfactant enhances the activity of the herbicidal active ingredient.

5. The method of claim 1 wherein:
a shell of the particles degrades due to a pH change due to the contact of water vapor from transpiration of the plant.

6. The method of claim 1 further comprising:
(c) coating the shell with a polymer associated with the herbicidal active ingredient, and
wherein the herbicidal active ingredient is released on leaves, stems, flowers and/or roots of a plant due to dissolution of the polymer by contact of water vapor from transpiration of the plant.

7. The method of claim 1 wherein:
the herbicidal active ingredient is non-selective.

8. The method of claim 1 wherein:
the herbicidal active ingredient is selective for monocot species.

9. The method of claim 1 wherein:
the herbicidal active ingredient is selective for dicot species.

10. The method of claim 1 wherein:
R¹ is phenyl.

11. The method of claim 1 wherein:
R¹ is C_{12—C}₂₄ alkyl.

12. The method of claim 1 wherein:
R¹ is substituted or unsubstituted acrylic acid.

13. The method of claim 1 wherein:
R¹ is polyethylene glycol.

14. The method of claim 1 wherein:
R¹ is alkylamine.

15. The method of claim 1 wherein:
R¹ is alkyl carboxylate.

16. The method of claim 1 wherein:
R¹ is alkyl quaternary amine.

17. The method of claim 1 further comprising:
adding a cationic agent to the emulsion.

18. The method of claim 17 wherein the cationic agent comprises a cationic polymer.

19. A method for increasing the bioactivity of a herbicide, the method comprising:
encapsulating the herbicide in a sol-gel microcapsule wherein the herbicide is in the salt form such that the herbicide is released on leaves, stems, flowers and/or roots of a plant due to dissolution of the salt by contact of water vapor from transpiration of the plant.

20. A method for increasing the bioactivity of a herbicide, the method comprising:
encapsulating the herbicide and a surfactant in a sol-gel microcapsule wherein the surfactant enhances the activity of the herbicide.
